(19) United States
(12) Patent Application Publication
(10) Pub. No.: US 2003/0154442 A1
(43) Pub. Date: Aug. 14, 2003

(54) Visualization tool for web analytics

(76) Inventor: Karen Papierniak, Fenton, MI (US)

Correspondence Address: JAMES M. STOVER, NCR CORPORATION, 1700 SOUTH PATTERSON BLVD, WHQ4, DAYTON, OH, 45479, US

(21) Appl. No.: 10/073,208

(22) Filed: Feb. 13, 2002

(51) Int. Cl. G06F 15/00

(52) U.S. Cl. 715/501.1; 715/513

(57) ABSTRACT

A web site visualization tool useful for business analytics is described. The visualization tool has a web server for displaying a graphical user interface (GUI), and a database for storing web pages and web page metrics. The web server includes a relationship engine for maintaining stored web page linkages and decision support tools for generating metrics related to the stored web pages. The web server displays a GUI to a user via a standard client web browser. In one embodiment, the GUI includes a standard report region with thumb-print size web page images located in the periphery surrounding the report region and connected to the corresponding entries in the report region. In another embodiment, the GUI includes a web page region and a web page information region having metrics and other information related to the web page displayed in the web page region. The web page is navigable by the user and navigation by the user causes the web server to update the web page information region with the appropriate information corresponding to the updated web page displayed.

### FIELD OF THE INVENTION

The present invention relates generally to web site visualization tools, and more particularly, to web site visualization tools for business analysis.

### BACKGROUND ART

Currently, web site analysis tools use uniform resource locators (URLs), page identifiers (page title, file type, directories), and content classification to identify web pages in a report. For example with reference to FIG. 1, a web page access report 10 is shown for a particular web site, e.g., a URL of http://www.abcd.com, and includes page identifiers listed in web page identifier column 12, user information listed in user column 14, and a count of individual web page accesses by particular users listed in click-through count column 16.

These types of identification lead to abstractions that can cause confusion as the web site grows and ages, For example, if multiple home pages were implemented for different types of user, they would be identified as home page 1, home page 2 and home page 3 (as shown in identifier column 12) and classified as home page for customers, home page for partners, and home page for visitors. In this example, understanding the differences between the home pages would aid in analyzing return on investment (ROI), use of on-line services, response to promotions, and ease of navigation.

Also, as the web site ages, i.e., as time passes, the web pages will be replaced or updated. When looking at reports spanning a longer period of time (over 3 months), the changes made to the web pages may not be reflected in the URL, page identifier, or classification. Therefore, there is a need in the art for a visualization tool to make these differences apparent by graphically displaying historical changes kept by the visualization database.

The relationship between the changing web pages, the data stored, the metrics and reports need to be visually represented while displaying the related reports and metrics for selected dates of interest. The change over time of web pages is easily reviewable by management and decision makers.

### DISCLOSURE/SUMMARY OF THE INVENTION

It is therefore an object of the present invention to provide a web site visualization tool for web analytics.

Another object of the present invention is to provide a web site visualization tool to graphically display historical changes to the web site and corresponding data.

The above described objects are fulfilled by a method of analyzing web sites using a visualization tool. The method includes storing web pages, analyzing the stored web pages and generating a web page metric of the stored web pages, and combining the web page metric with at least one of the stored web pages in a graphical user interface.

Another aspect of the invention includes a web site visualization tool for web analytics including a graphical user interface, a database storing historical data, and a relationship engine able to retrieve historical data from the database and able to provide analyzed data to the graphical user interface. The relationship engine is able to map new pages (or groups of pages) to replaced pages (or groups of pages). This helps a user analyze the web data consistently over a longer period of time.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a prior art web page access report;

FIG. 2 is a high level functional diagram of a computer system useable with an embodiment of the present invention;

FIG. 3 is a high level functional diagram of an embodiment of the present invention;

FIG. 4 is a sample report generated by an embodiment of the present invention;

FIG. 5 is another sample report generated by an embodiment of the present invention.

FIG. 6 is a sample OLAP tool report output generated by an embodiment of the present invention;

FIG. 7 is another sample OLAP tool report output generated by an embodiment of the present invention; and

FIG. 8 is a sample of metrics available for an OLAP report generated by an embodiment of the present invention.

### BEST MODE FOR CARRYING OUT THE INVENTION

A method and apparatus for web site visualization for business analytics are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

Hardware Overview

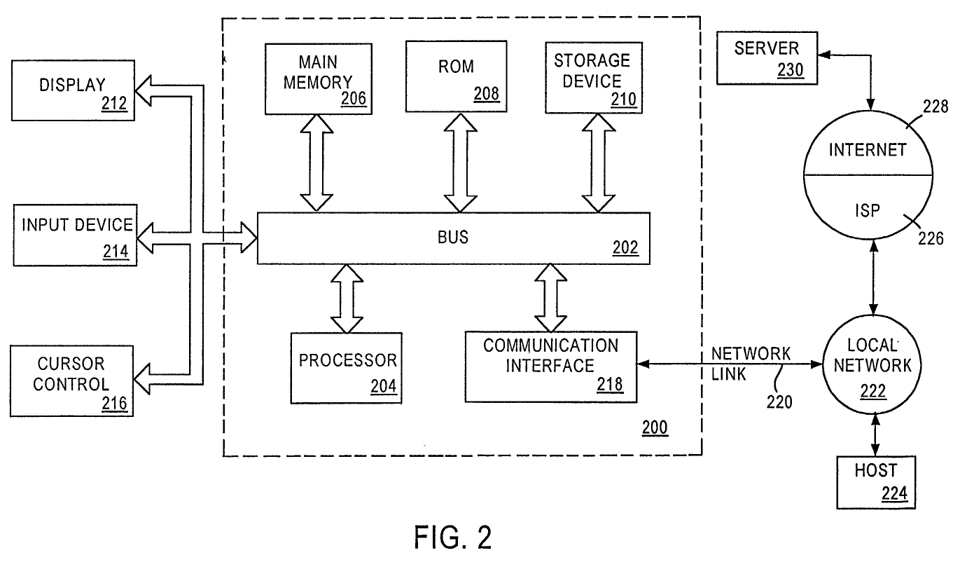

FIG. 2 is a block diagram illustrating an exemplary computer system 200 upon which an embodiment of the invention may be implemented. The present invention is usable with currently available personal computers, mini-mainframes and the like.

Computer system 200 includes a bus 202 or other communication mechanism for communicating information, and a processor 204 coupled with the bus 202 for processing information. Computer system 200 also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to the bus 202 for storing static information and instructions for the processor 204. A storage device 210, such as a magnetic disk or optical disk, is provided and coupled to the bus 202 for storing information and instructions.

Computer system 200 may be coupled via the bus 202 to a display 212, such as a cathode ray tube (CRT) or a flat panel display, for displaying information to a computer user. An input device 214, including alphanumeric and other keys, is coupled to the bus 202 for communicating information and command selections to the processor 204. Another type of user input device is cursor control 216, such as a mouse, a trackball, or cursor direction keys for communicating direction information and command selections to processor 204 and for controlling cursor movement on the display 212. This input device typically has two degrees of freedom in two axes, a first axis (e.g., x) and a second axis (e.g., y) allowing the device to specify positions in a plane.

The invention is related to the use of a computer system 200, such as the illustrated system, to provide a web site visualization tool for business analysis. According to one embodiment of the invention, a web site visualization tool is provided by computer system 200 in response to processor 204 executing sequences of instructions contained in main memory 206 to display web pages for business analysis. Such instructions may be read into main memory 206 from another computer-readable medium, such as storage device 210. However, the computer-readable medium is not limited to devices such as storage device 210. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 206 causes the processor 204 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 200 also includes a communication interface 218 coupled to the bus 202. Communication interface 208 provides a two-way data communication as is known. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals which carry digital data streams representing various types of information. Although not required for operation of the present invention, the communications through interface 218 may permit transmission or receipt of the visualization tool for web analytics software or access to the data needed by the visualization tool. For example, two or more computer systems 200 may be networked together in a conventional manner with each using the communication interface 218.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication services through the world wide packet data communication network now commonly referred to as the “Internet” 228. Local network 222 and Internet 228 both use electrical, electromagnetic or optical signals which carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218. In accordance with the invention, one such downloaded application provides for analysis of web sites using a visualization tool, as described herein.

The received code may be executed by processor 204 as it is received, and/or stored in storage device 210, or other non-volatile storage for later execution. In this manner, computer system 200 may obtain application code in the form of a carrier wave.

Top Level Description

The Visualization Tool for Web Analytics (VTWA) combines web pages with their associated metrics in a single view to the business analyst and web site designer. The combination removes a layer of abstraction and assists the analyst or designer in:

making improvements to their web sites;

measuring ROI or promotional effectiveness;

comparing metrics of current web pages to past web pages; and

comparing web pages that are similar in function but different in presentation.

The visualization tool adds a graphical presentation to the standard spread sheet reporting approach. The visualization tool combines the reports with the web pages to present an integrated view to the business analysts.

Detailed Description

Functional

The visualization tool takes a decision support tool, like on-line analytical processing (OLAP), and combines the web data being analyzed with the actual web pages. The visualization tool removes a layer of abstraction and helps clarify the data being analyzed.

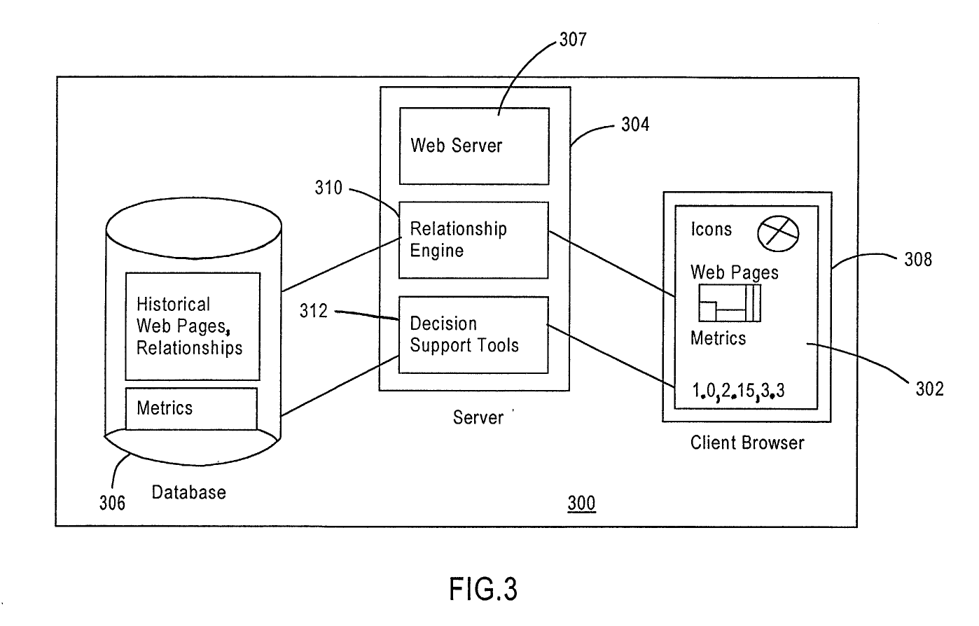

FIG. 3 is a high-level functional diagram of the VTWA 300 of the present invention. The VTWA 300 includes a graphical user interface (GUI) 302 for displaying information to a user of the VTWA and receiving commands from the user, a server 304 for responding to user commands entered via GUI 302 and analyzing data in a database 306, and the database for storing web pages and web page-related information. Web server 307 serves the web pages in response to user browser requests. Web server 307 is shown as a part of server 304 for simplicity and may be separate from server 304 in alternate embodiments. The GUI 302 is shown in FIG. 3 as being displayed and manipulated using a client browser 308 and may be any known web browser, e.g., Internet Explorer available from Microsoft Corporation. It is to be understood that in alternate embodiments different browsers may be used and a separate application may be used in place of a web browser to provide GUI 302.

Graphical User Interface

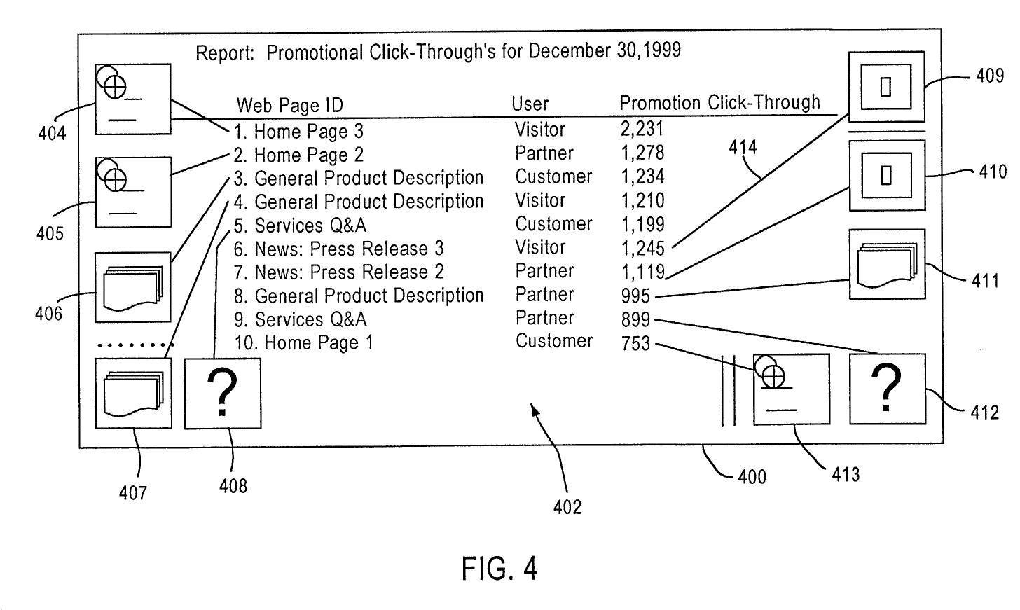

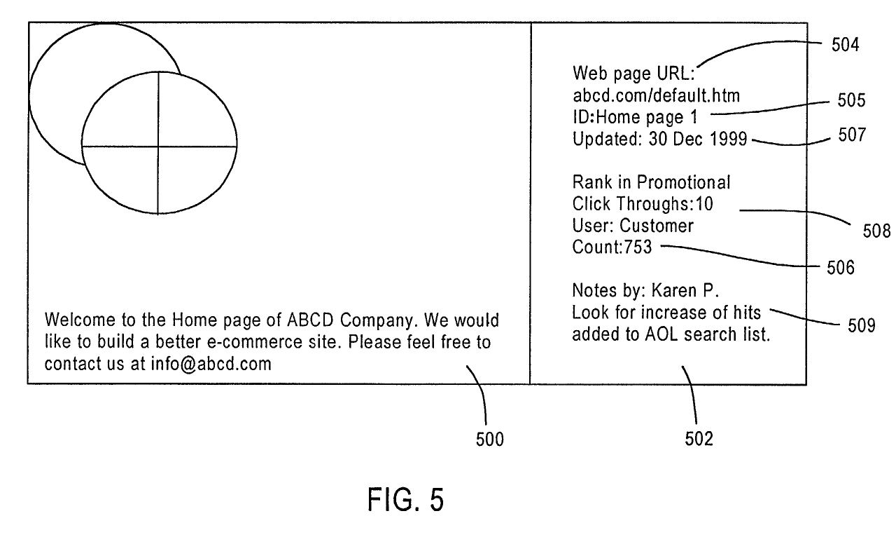

The GUI 302 displays icons, web pages, and metrics to the user in a visual format to facilitate the user's understanding. The GUI 302 is a standard hypertext markup language (HTML) based or extensible markup language/extensible stylesheet language (XML/XSL) based interface. Example output formats are shown in FIGS. 4 and 5, discussed in more detail below.

Server

Server 304 has a relationship engine 310 for determining the relationships of web pages stored in database 306 and decision support tools 312 for analyzing the web pages in database 306 and generating metrics related to the web pages. The relationship engine 310 maintains the linkages between web pages displayed to the user via GUI 302 and supports the user navigating the historical web pages stored in database 306.

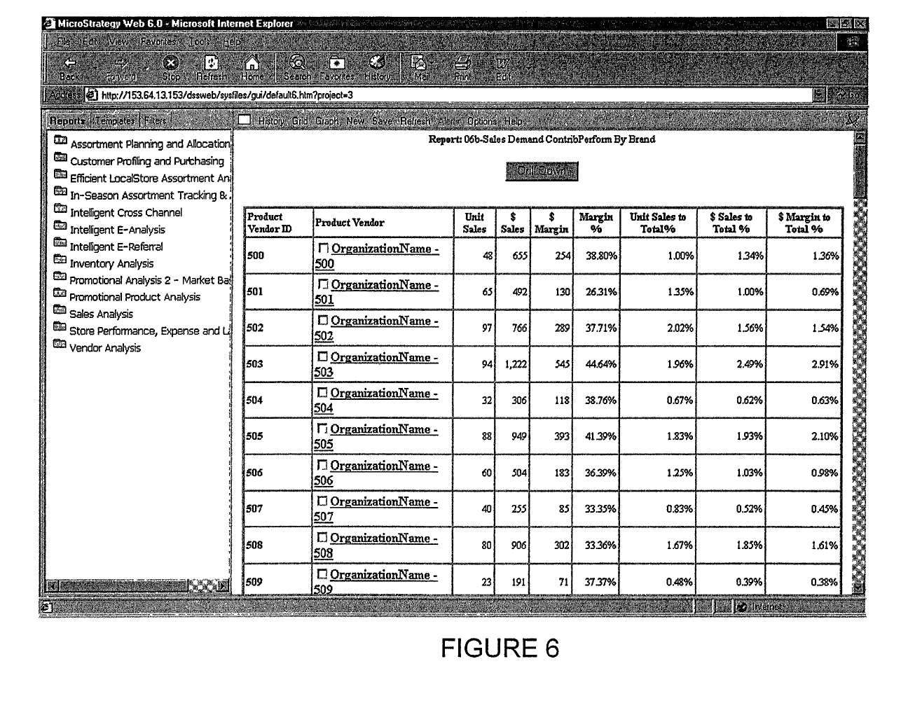

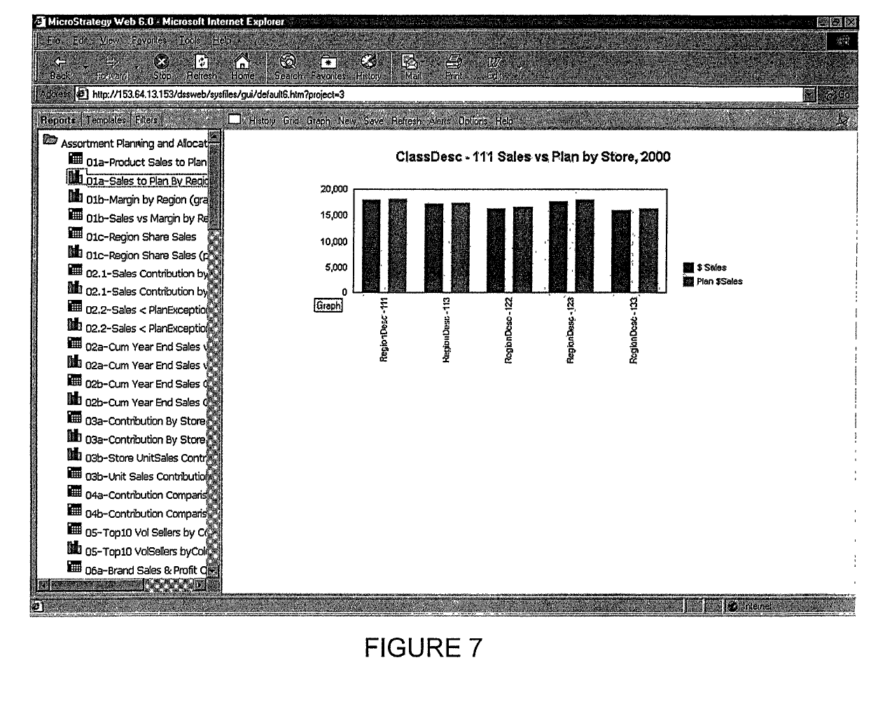

The relationship engine 310 is a combination of a logical data model (including historical records) and active links to web pages and grouping of data by web page categories, time, or other dimensions (typically performed when setting up reports or cubes in an OLAP tool). FIGS. 6 and 7 are example OLAP reports available using an OLAP tool.

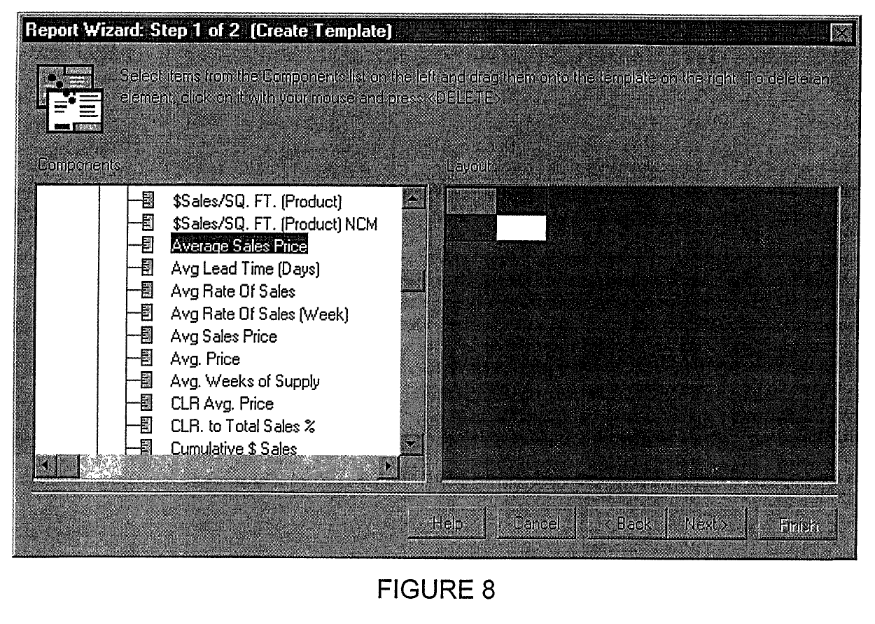

The decision support tools 312 are of an on-line analytical processing (OLAP) type known in the prior art, e.g., MicroStrategy 7 Intelligence Server (previously named DSS Server) and Cognos' PowerPlay. The decision support tools 312 generate and update various metrics related to the web pages, e.g., number of promotional click-throughs for a particular web page. Additional metrics include average sales price, average lead time in days, average rate of sales, average rate of sales per week, average price, and average weeks of supply. More specifically with respect to the web page environment the metrics include the number of visitors per page, number of visitors per period of time, number of visitors by domain, and number of baskets abandoned on an electronic commerce site. An example list of metrics for the example reports of FIGS. 6 and 7 is shown in FIG. 8.

Database

The database 306 includes historical web page information, web page relationships, and metrics pertaining to the web pages. For example, the multiple versions of a web page over time may be maintained as well as the relationships or links that were active at the time and the web pages pointed to by the relationships may be stored, if desired. Metrics generated by decision support tools 312 are stored in database 306 if they are frequently used, e.g., the number of promotional click-throughs for a particular web page may be stored in database 306 with a relationship to the web page to which the metric applies. Typically, metrics are calculated in real-time and not stored in the database 306. Additionally, many OLAP tools cache reports and data in an OLAP server, e.g., server 304 of FIG. 3.

EXAMPLE GUIs

Two methods of implementing the graphical user interface 302 containing icons, web pages, and report data are now discussed in detail. One method is to add thumb-print-size web pages to a browser report 400, as shown and described with reference to FIG. 4, and the other is to add metric data to individual web pages as shown in FIG. 5.

### Example One

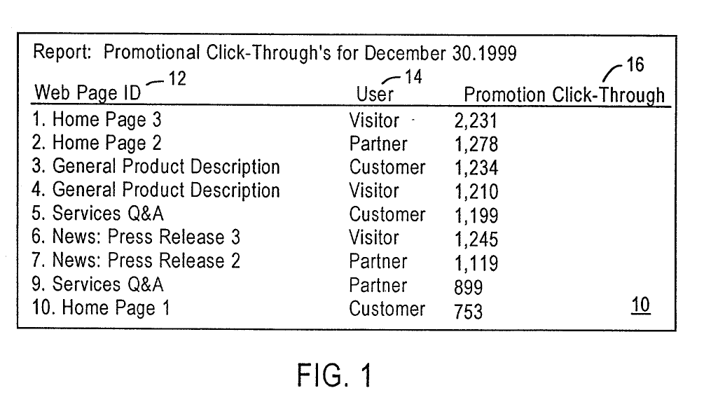

With reference to FIG. 4, the browser report 400 includes a central report region 402, similar to the report 10 of FIG. 1 of the prior art, and numerous thumb-print size web page images 404-413 located in the periphery surrounding report region 402 and indicator lines connecting the thumb-print size web page images to the corresponding report region 402 entries. Exemplary indicator line 414 connects the sixth report entry having an identifier of “News: Press Release 3” with the thumb-print size web page image 409. Each of the other thumb-print size web page images is accordingly connected to its corresponding report entry.

The thumb-print-size web page images may be expanded, shaded to show age, and bars may be placed on top to show the web page location in the web site hierarchy. The thumb-print size web page images 404-413 may be icons indicating the contents of the web pages or they may be scaled images of the actual web pages. In an alternate embodiment, the web page images 404-413 are actual scaled “live” versions of the web pages. That is, each web page image 404-413, is simply a smaller version of the actual web page which is usable, i.e., browseable, by the user.

It is to be understood that even though entries of the report region 402 are shown as sorted by promotion click-throughs, the entries may also be displayed by different sorts or unsorted.

### Example Two

The second method uses existing web pages and adds the metrics to the web pages, as shown and described with reference to FIG. 5. As the business analyst or web designer browses the web site, related metrics for the web page will be displayed at the same time.

With reference to FIG. 5, a web page 500 is shown as it appears to users browsing the web site. Additionally, on the right-hand portion of the page, a web page information region 502 is shown displaying metric and other web page 500 related information to the user. The right-hand portion of the page in an alternate embodiment informs the user if the page is currently active or if it has been updated, replaced by another (as shown) or discontinued. Activating links on web page 500 would cause the web page 500 to be updated in known fashion by server 304 to display the web page using web server 307 to which the link referred. Further, the web server 307 would update the right-hand portion, or web page information region 502, to display the information pertaining to the web page 500 now displayed.

Web page information region 502 includes information pertaining to web page 500 similarly to the information presented in report region 402 of FIG. 4, such as web page URL 504, web page identifier 505, and promotional click-throughs count 506. Additional information about web page 500 including the date the web page was updated 507, e.g., Dec. 30, 1999, the rank of the web page 500 in promotional click-through counts 508, e.g., tenth, and any additional notes 509 entered by the user is also displayed to the user.

Web page 500 is browseable by the user who is an analyst desiring insight into the business aspect of a web site, thereby enabling the user/analyst to easily peruse a web site and view metrics related to each of the web pages in a context similar to users of the web site.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of analyzing web sites using a visualization tool, comprising the following steps:
storing web pages;
analyzing the stored web pages and generating a web page metric of the stored web pages; and
combining the web page metric with at least one of the stored web pages in a graphical user interface.

2. The method as claimed in claim 1, wherein the graphical user interface is an html-based or XML/XSL-based interface.

3. The method as claimed in claim 1, wherein the web page metric include at least one of number of promotional click-throughs.

4. The method as claimed in claim 1, wherein the graphical user interface includes a report region and at least one web page image corresponding to an entry in the report region.

5. The method as claimed in claim 4, wherein the report region includes a web page metric.

6. The method as claimed in claim 1, wherein the graphical user interface includes a web page region and a web page information region.

7. The method as claimed in claim 6, wherein the web page information region includes a web page metric.

8. A web site visualization tool for web analytics, comprising:
a graphical user interface;
a database storing historical data; and
a relationship engine able to retrieve historical data from said database and able to provide analyzed data to said graphical user interface.

9. The web site visualization tool as claimed in claim 8, wherein the graphical user interface is an html-based or XML/XSL-based interface.

10. The web site visualization tool as claimed in claim 8, wherein the analyzed data provided to said graphical user interface includes a web page metric.

11. The web site visualization tool as claimed in claim 10, wherein the web page metric include at least one of number of promotional click-throughs.

12. The web site visualization tool as claimed in claim 8, wherein said graphical user interface includes a report region and at least one web page image corresponding to an entry in the report region.

13. The web site visualization tool as claimed in claim 12, wherein the report region includes a web page metric.

14. The web site visualization tool as claimed in claim 8, wherein the graphical user interface includes a web page region and a web page information region.

15. The web site visualization tool as claimed in claim 14, wherein the web page information region includes a web page metric.
